(19) United States
(12) Patent Application Publication
(10) Pub. No.: US 2011/0180634 A1
(43) Pub. Date: Jul. 28, 2011

(54) NOZZLE BODY, NOZZLE ASSEMBLY AND FUEL INJECTOR, AND METHOD FOR PRODUCING A NOZZLE BODY

(76) Inventors: Tobias Sander, Hohenkirchen-Siegertsbrunn (DE); Alexander Vincon, Limbach-Oberfrohna (DE)

(21) Appl. No.: 13/059,202

(22) PCT Filed: Jul. 8, 2009
(86) PCT No.: PCT/EP09/58662

§ 371 Date: Mar. 28, 2011

(30) Foreign Application Priority Data
Aug. 27, 2008 (DE) 10 2008 039 920.5

(51) Int. Cl. F02M 61/00

(52) U.S. Cl. 239/533.2

(57) ABSTRACT

A nozzle body (20) for a nozzle assembly (2) of a fuel injector (1), particularly of a common-rail-fuel injector (1), has a needle bore (26, 22) for a needle piston (36) of a nozzle needle (30), wherein the needle bore (26) ends in a blind hole (266) above a nozzle needle seat (262) for a sealing surface (362) of a nozzle needle tip (360) of the nozzle needle (30), into the blind hole a tappet (366) of the nozzle needle tip (360) can be inserted, wherein a recess (264) is provided in a transitional region (202) from the nozzle needle seat (262) to the blind hole (266). A method introduces a nozzle bore (22) into a nozzle body (20) of a fuel injector (1), particularly of a common-rail-fuel injector (1).

### CROSS-REFERENCE TO RELATED APPLICATIONS

This application is a U.S. National Stage Application of International Application No. PCT/EP2009/058662 filed Jul. 8, 2009, which designates the United States of America, and claims priority to German Application No. 10 2008 039 920.5 filed Aug. 27, 2008, the contents of which are hereby incorporated by reference in their entirety.

### TECHNICAL FIELD

The invention relates to a nozzle body for a nozzle assembly, and to a nozzle assembly for a fuel injector, in particular a common rail fuel injector, for a combustion chamber of an internal combustion engine. The invention further relates to a fuel injector having a nozzle body according to the invention and to a nozzle assembly according to the invention. In addition the invention relates to a method for introducing a nozzle bore into a nozzle body of a fuel injector.

### BACKGROUND

Increasingly stringent statutory provisions relating to admissible pollutant emissions from internal combustion engines for motor vehicles make it necessary to take measures serving to reduce the pollutant emissions. One starting point in attempting this is to obtain an improved fuel induction into the combustion chambers of the internal combustion engine. A correspondingly improved fuel induction can be achieved if fuel is metered under high pressure by means of a fuel injector. In the case of a diesel internal combustion engine such fuel pressures are in excess of 2,000 bar, such fluid pressures placing great demands on the material and on a design of a nozzle assembly of the fuel injector.

In a fuel injector an injection of fuel is usually controlled by means of a nozzle needle, which is displaceably supported in the fuel injector and which according to its position opens or closes one or more spray holes of a nozzle body of the nozzle assembly for the fuel to be injected. The nozzle needle is usually activated by an actuator, which acts either directly or by way of a servo-valve and a control chamber on a transmission element (plunger), which generally interacts mechanically with the nozzle needle. Here the nozzle needle and the transmission element are usually supported on a plain bearing with a slight play in a sliding guide, this bearing generally being lubricated by the fuel to be injected.

In order to reduce the pollutant emissions and also to minimize a fuel consumption of the internal combustion engine, it is desirable that a series of fuel injectors used should as far as possible exhibit a substantially identical performance to one another in all functional ranges. Besides a start of injection, this applies in particular to a fuel injection quantity per injection and per individual injection. Problems with this include hydraulic diameters that vary according to the fuel injector in an area downstream of a nozzle needle seat.

In fuel injectors having a blind hole injection nozzle, for example, this stems from the fact that on the one hand the blind hole is of internally conical design and on the other that when introducing the nozzle needle seat upstream of the blind hole the blind hole is widened to a greater or lesser degree depending on a rate of feed of a tool into a needle bore of the injection nozzle. The conical design of the blind hole results in varying diameters in an admission area between the nozzle needle of substantially constant dimensions and the blind hole directly adjoining the nozzle needle seat, the diameters, depending on the fuel injector, being reflected in differing hydraulic diameters and thus in deviations in injection quantities.

### SUMMARY

According to various embodiments, an improved nozzle body, an improved nozzle assembly and an improved fuel injector, in particular an improved common rail fuel injector, for a combustion chamber of an internal combustion engine can be specified. According to further embodiments, an improved method for producing a nozzle body of a fuel injector can be specified.

According to an embodiment, a nozzle body for a nozzle assembly of a fuel injector, in particular a common-rail fuel injector, may have a needle bore for a needle plunger of a nozzle needle, wherein the needle bore opens out by way of a nozzle needle seat for a sealing face of a nozzle needle tip of the nozzle needle in a blind hole, into which a pintle of the nozzle needle tip is immersible, wherein an offset is provided in a transitional area from the nozzle needle seat to the blind hole.

According to a further embodiment, the offset inside a wall of the nozzle body may have a substantially hollow cylindrical contour. According to a further embodiment, the nozzle needle seat may merge in a longitudinal direction of the nozzle body into the wall of the blind hole by way of the offset embodied as a step. According to a further embodiment, an intersection edge between the nozzle needle seat and the offset may result from an intersection between a cone and a cylinder. According to a further embodiment, an intersection edge between the offset and the blind hole may result from an intersection between a cylinder and a cone.

According to another embodiment, a nozzle assembly for a fuel injector, may have a defined hydraulic diameter between a nozzle needle and a nozzle body of the nozzle assembly downstream of a nozzle needle seat of the nozzle body, wherein the nozzle needle is displaceably guided in a nozzle bore of the nozzle body and with a sealing face provided thereon can be brought to bear tightly against the nozzle needle seat of the nozzle body, and the nozzle bore comprises a cylindrical portion downstream of the nozzle needle seat.

According to a further embodiment of the nozzle assembly, the nozzle bore may open out in a blind hole downstream of the cylindrical portion. According to a further embodiment of the nozzle assembly, the nozzle needle, at a nozzle needle tip, may comprise a pintle, which is immersible into the blind hole, an external contour of the pintle preferably being of a similar design to an internal contour of the blind hole. According to a further embodiment of the nozzle assembly, the nozzle body may be designed as described above.

According to a further embodiment of the nozzle body or nozzle assembly, the nozzle needle seat is of truncated cone-shaped design and/or the blind hole is internally of conical design. According to a further embodiment of the nozzle body or nozzle assembly, in a finished state of the nozzle body of the offset or the cylindrical portion may be 2 μm to 250 μm, preferably 5 μm to 100 μm, in particular 10 μm to 75 μm, more preferably 15 μm to 50 μm and most preferably 20 μm to 35 μm. According to a further embodiment of the nozzle body or nozzle assembly, the intersection edge between the nozzle needle seat and the offset or the cylindrical portion can be a sharp edge. According to a further embodiment of the nozzle body or nozzle assembly, the intersection edge between the nozzle needle seat and the offset or the cylindrical portion may not be machined after introducing the offset or the cylindrical portion.

According to yet another embodiment, a fuel injector, in particular a common rail fuel injector, for a combustion chamber of an internal combustion engine, may have a nozzle body as described above or a nozzle assembly as described above, and an injector assembly.

According to yet another embodiment, in a method for introducing a nozzle bore in a nozzle body of a fuel injector, in particular a common-rail fuel injector, a needle bore of the nozzle bore may be first introduced before providing a nozzle needle seat in the nozzle body and an offset or a cylindrical portion in or on a wall of the nozzle body, the offset or cylindrical portion internally adjoining the nozzle needle seat in a longitudinal direction of the nozzle body.

According to a further embodiment of the method, a blind hole, in which the needle bore of the nozzle body opens out, can furthermore be provided in the nozzle body. According to a further embodiment of the method, the nozzle needle seat and the offset or the cylindrical portion and/or the blind hole can be provided in the nozzle body by a single tool. According to a further embodiment of the method, the offset or the cylindrical portion can be first provided before grinding in the nozzle needle seat. According to a further embodiment of the method, the nozzle body may be formed as described above.

### BRIEF DESCRIPTION OF THE DRAWINGS

The invention will be explained in more detail below on the basis of exemplary embodiments with reference to the drawing attached, in which:

FIG. 1 shows a central sectional view of one embodiment of a fuel injector;

FIG. 2 shows a central sectional view of a free end portion of a nozzle assembly having a nozzle body according to the state of the art, for a fuel injector; and

FIG. 3 shows a central sectional view of a free end portion of a nozzle assembly having a nozzle body, for a fuel injector.

### DETAILED DESCRIPTION

According to various embodiments, one can come one step closer to the aim of providing durable fuel injectors for internal combustion engines which exhibit a substantially identical performance to one another, in order to minimize pollutant emissions and the fuel consumption of internal combustion engines. The particular aim is to achieve this through a simple structural modification to a design of the fuel injector, in particular its nozzle body, in order to allow an efficient application according to various embodiments. It is intended here that the structural modification should lend itself to execution in an existing machining set-up of the nozzle body, for example for producing its nozzle bore.

In one embodiment a nozzle body for a nozzle assembly of a fuel injector has a nozzle bore for a nozzle needle. The nozzle bore opens out by way of a nozzle needle seat for a sealing face of a nozzle needle tip of the nozzle needle in a blind hole, into which a pintle of the nozzle needle tip is immersible. According to various embodiments the nozzle bore comprises a cylindrical portion downstream of the nozzle needle seat.

The cylindrical portion may be part of an internal offset on a wall of the nozzle body, for example. It is preferred here if the offset is embodied as a step, by way of which the nozzle needle seat in a longitudinal direction of the nozzle body merges into a wall of the blind hole. That is to say in such an embodiment the nozzle needle seat merges by way of an edge into the cylindrical portion, the latter merges by way of an edge into a portion arranged substantially at right angles to the longitudinal direction of the nozzle body, and the latter portion in turn merges by way of an edge into the blind hole. Here a respective edge may be a sharp edge or may be re-machined.

It is furthermore possible to provide the cylindrical portion according to various embodiments between the nozzle needle seat and the blind hole adjoining this, without providing an offset inside the wall of the nozzle body. That is to say in such an embodiment the nozzle needle seat merges by way of an edge into the cylindrical portion and the latter in turn merges by way of an edge into the wall of the blind hole. In this embodiment the respective edge may again be a sharp edge or may be re-machined.

In one embodiment a nozzle assembly for a fuel injector comprises a nozzle needle, which is moveably guided in a nozzle bore of a nozzle body and which with a sealing face provided thereon can be brought to bear tightly against the nozzle needle seat of the nozzle body. An offset is provided in a transitional area from the nozzle needle seat to the blind hole. This results in a defined hydraulic diameter between the nozzle needle and the nozzle body downstream of the nozzle needle seat, since it is possible to assume a dimensional stability on the part of the nozzle needle, because it is comparatively easy to produce and tight tolerances are therefore also assured, particularly in the case of the relevant diameters of the nozzle needle.

According to various embodiments the nozzle bore may open out in a blind hole downstream of the offset. It is then preferred here for the nozzle needle, at its nozzle needle tip, to have a pintle, which is immersible into the blind hole, an external contour of the pintle being similar to or substantially congruent with an internal contour of the blind hole, but of smaller design. The respective edges of the offset, that is to say those with the nozzle needle seat, the blind hole and the edge inside the offset, may again be sharp-edged or re-machined.

In the embodiments it is preferred that the nozzle needle seat be of truncated cone-shaped design and/or that the blind hole be of internally conical design. According to various embodiments an intersection edge between the nozzle needle seat and the cylindrical portion or the offset results from an intersection between a cone and a cylinder. In the same way an intersection edge between the cylindrical portion or the offset and the blind hole results from an intersection between a cylinder and a cone.

A fuel injector according to various embodiments, in particular a common rail fuel injector according to various embodiments, for a combustion chamber of an internal combustion engine, comprises a nozzle body in a nozzle assembly, or a nozzle assembly, and an injector assembly, the nozzle assembly and the injector assembly preferably being fixed to one another by means of a nozzle-retaining nut.

In one embodiment of the method a needle bore is first introduced before providing a nozzle needle seat and a downstream offset or cylindrical portion adjoining the nozzle needle seat in or on a wall of the nozzle body. It is furthermore preferred if a blind hole, in which the needle bore of the nozzle body terminates, is provided in the nozzle body. The nozzle needle seat can preferably be ground in and/or other finishing operations can be undertaken after providing the offset or the cylindrical portion. That is to say after introducing them into the nozzle body the corresponding portions of the nozzle bore have a corresponding machining allowance.

Said portions of the nozzle bore can be produced by individual tools, or a plurality of tools may be combined in one single tool. Thus it is preferable, for example, to use a deep-boring tool to produce the needle bore initially as a center blind hole bore, which at its base is then machined further by means of a single tool, which introduces the nozzle needle seat, the offset and the cylindrical portion and the blind hole. Any final machining that may be necessary, particularly of the nozzle needle seat, then takes place at a later stage.

According to various embodiments it is possible, assuming nozzle needles of accurate dimensions, to ensure a defined and reproducible hydraulic diameter between the nozzle needle and transitional area between the seating for the nozzle needle and the blind hole. The solution according to various embodiments can be applied rapidly and cost-effectively, since on the one hand it can be incorporated in an existing set-up (machining center) for the nozzle body; and on the other hand it only increases manufacturing outlay for the nozzle body very slightly, if at all, since only one additional portion of a bore or a milling is used. This portion can be provided in the nozzle body by means of a redesigned tool without an additional machining operation.

The high cost of measuring and process control for producing a transition from the nozzle needle seat into the wall of the blind hole, which is necessary in the state of the art, is furthermore eliminated, since for this comparatively tight tolerances are necessary in order to obtain satisfactory results in respect of the hydraulic diameter in the transitional area. This also means that less scrap occurs due to parts which are not accurate in size. Furthermore the invention does not require any further modifications to an existing fuel injector design, that is to say the invention can be applied without additional interventions in an existing fuel injector design.

In addition the structural modification according to various embodiments results in a constant length of the nozzle needle seat from one injection nozzle to the next. This results in an identical bearing surface for the nozzle needle in all injection nozzles and therefore, under identical operating conditions, in a constant seat wear of the injection nozzles in a set. As a result the effects of the nozzle needle seat wear on injection quantity differences in a set of fuel injectors can be minimized. That is to say the ageing processes of all fuel injectors in a set can thereby be more accurately predicted and better compensated for through a correspondingly modified activation, which minimizes a fleet consumption and the pollutant emissions from correspondingly equipped motor vehicles.

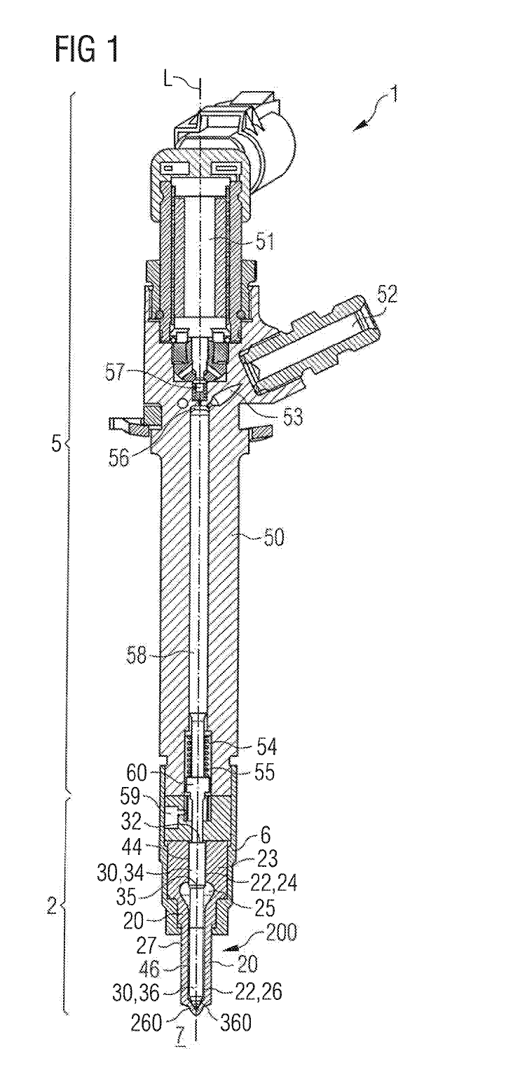

FIG. 1 shows a common-rail fuel injector 1, which comprises a nozzle assembly 2 and an injector assembly 5. The nozzle assembly 2 and the injector assembly 5 are fixed together by means of a nozzle-retaining nut 6 so that they are fluid tight. The invention is not intended to be limited to a common-rail fuel injector 1, however, but can be applied to all fuel injectors 1, such as a pump-nozzle fuel injector, for example.

The injector assembly 5 comprises an injector body 50, on or in which an actuator 51 is provided. The actuator 51 is preferably embodied as a piezo actuator 51, but may also be designed, for example, as a solenoid actuator 51. The actuator 51 may be connected to a mechanical or hydraulic transducer (not represented in the drawing), which is located in the injector body 50. The actuator 51 and the transducer then form a servo-actuator.

The injector body 50 further comprises a high pressure-side fluid connection 52 for a fuel to be injected, the fluid connection 52 being hydraulically coupled to a high-pressure line 53 formed in the injector body 50. The fuel injector 1 can be connected by way of the high-pressure connection 52 to a high-pressure fluid circuit (not represented in the drawing) of an internal combustion engine. The high-pressure line 53 supplies a control chamber 56, formed in the injector body 50, and the nozzle assembly 2 (see below) with fuel under high fluid pressure.

A valve element 57, which is mechanically connected to the actuator 51, is provided on (not shown in the drawing) or in the control chamber 56. The control chamber 56 is hydraulically coupled to or isolated from a low-pressure area of the fuel injector 1 as a function of the position of the valve element 57. The pressure in the control chamber 56 acts by way of a plunger 58 and a pressure plunger 60 by way of a front face 32 on a nozzle needle 30 of the nozzle assembly 2. Here the front face 32 of the nozzle needle 30 is remote from a nozzle needle seat 262 or a sealing face 362 or a sealing cone 362 of the nozzle needle 30.

The nozzle needle 30 is further pressed by a nozzle needle spring 55, located in a spring chamber 54 of the injector body 21, either directly or, as shown in the drawing, by the pressure plunger 60 towards its nozzle needle seat 262, so that it is securely closed in the absence of a high fluid pressure. In embodiments the plunger 58 may be integrally formed from the same material as the pressure plunger 60.

The nozzle assembly 2 of the fuel injector 1 comprises a nozzle body 20 having a nozzle bore 22, and an annular chamber on the nozzle bore 22, the nozzle needle 30 preferably integrally formed from the same material being displaceably guided in the nozzle bore 22. The annular chamber 25 formed in the nozzle body 20 and surrounding the nozzle needle 30 in the area of its exposed annular area 35 is hydraulically connected to the high-pressure line 53 of the injector body 50, so that when the high fluid pressure is present on the high-pressure connection 52 the high fluid pressure basically always prevails in the annular chamber 25.

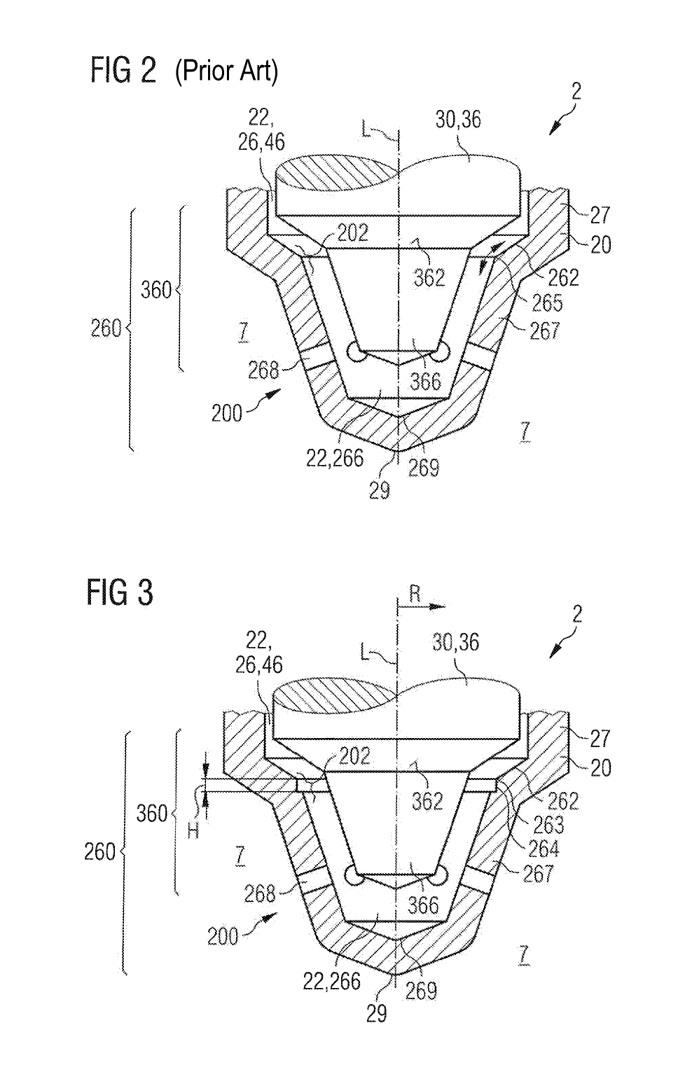

Depending on pressure in the control chamber 56, the nozzle needle 30 is either pressed into its nozzle needle seat 262 (valve element 57 in closed position, high fluid pressure prevails in the control chamber 56) or, if the control chamber 56 is hydraulically connected to the low-pressure area of the fuel injector 1 (valve element 57 in an open position, high fluid pressure no longer prevails in the control chamber 56) moves away from its valve needle seat 262 due to the high fluid pressure in the annular chamber 25 and the exposed annular area 35 formed thereon, so that fuel can be injected into a combustion chamber 7 of an internal combustion engine through at least one spray hole 268 (see FIG. 2 or 3) of an injection nozzle 200 of the fuel injector 1.

In the embodiment represented in FIG. 1 the nozzle needle 30 comprises a needle plunger 36, which merges by way of the exposed annular area 35 into the guide plunger 34. The needle plunger 36 is situated in a needle stem 27 of the nozzle body 11, a needle gap 46 being formed in the nozzle bore 22 between the needle stem 27 and the needle plunger 36, which gap basically allows an unrestricted admission of fuel to the nozzle needle seat 262. That part of the nozzle bore 22 in which the needle plunger 36 is located is also referred to as the needle bore 26.

The guide plunger 34 of the nozzle needle 30 is guided and supported in a guide stem 23 of the nozzle body 20, a guide seal gap 44, which allows only a restricted passage of fuel from the annular chamber 25 to the low-pressure area and thence to a low pressure-side fluid connection 59 of the fuel injector 1, being formed between the nozzle bore 22 of the guide stem 23 and the guide plunger 34. That part of the nozzle bore 22 in which the guide plunger 34 is arranged is also referred to as the guide bore 24.

Other embodiments of the fuel injector 1 can naturally be used. Thus it is possible, for example, to activate the nozzle needle 30 directly or inversely by means of the actuator 51. In the case of a directly actuated nozzle needle 30 the pressure plunger 60 is an integral part of a head plate of the actuator 51. A lifting movement of the actuator 51 can furthermore be augmented by means of a mechanical or a hydraulic lever.

In particular it is possible to guide the nozzle needle 30 entirely in a high-pressure area of the fuel injector 1 (not shown in the drawing). Here the nozzle needle 30 is guided on a middle portion in proximity to its front face 32, the front face 32 of the nozzle needle 30 being terminated by means of a pressure bell. In this case the nozzle needle 30 is preferably actuated by a lever.

FIGS. 2 (state of the art) and 3 in each case show a free longitudinal end portion of the fuel injector 1 or its nozzle assembly 2 fitting into the combustion chamber 7 of the internal combustion engine. Here FIGS. 1 and 2 basically represent the injection nozzle 200 of the nozzle assembly 2, which comprises a nozzle body tip 260, in which a nozzle needle tip 360 is moveably arranged.

In one exemplary embodiment the nozzle bore 22 extending through the annular chamber 25 and the needle bore 26 terminates in a base 269 of a blind hole 266. The nozzle needle 30 is basically guided entirely in the nozzle bore 22 of the nozzle body 20, a preferably conical pintle 366 of the nozzle needle tip 360 being immersible in the preferably conical blind hole 266, in order to minimize the clearance volume of the blind hole 266. For this purpose an external face of the pintle 366 is matched to an internal face of the blind hole 266, that is to say the volume of the pintle 366 is slightly smaller than the volume of the blind hole 266. In a closed position of the nozzle needle 30 the pintle 366 preferably immerses completely in the blind hole 266.

In the closed position of the nozzle needle 30 this bears with a preferably truncated cone-shaped sealing face 362 (sealing cone 362) formed at its nozzle needle tip 360 fluid-tightly against the likewise preferably truncated cone-shaped nozzle needle seat 262 of the nozzle body 20. In the open position of the nozzle needle 30 represented in FIGS. 2 and 3 it is lifted off from the nozzle needle seat 262. Fuel can flow largely unrestricted into the blind hole 266 through the needle gap 46 formed between the nozzle needle 30 and the needle stem 27 of the needle body 20 and from there can pass by way of the spray holes 268 provided in the wall 267 of the blind hole 266 into the combustion chamber 7.

Differences occurring in an axial position of a transition from the nozzle needle seat 262 into the blind hole 266, that is to say in an axial direction L or along the longitudinal axis L of the nozzle body 20, are a problem. In the state of the art represented in FIG. 2 an intersection edge 265 of the nozzle needle seat 262 and the start of a wall 267 of the blind hole 266 may lie in an intersection area 202, which is also illustrated by a double arrow on the right-hand side of FIG. 2. That is to say this intersection edge 265 is more or less remote from the base of the blind hole 266, depending on production conditions.

This intersection edge 265 resulting from an intersection of two cones stems from various production operations and has an influence on a resulting hydraulic diameter between the nozzle needle tip 360 and a corresponding portion of the nozzle bore 22 in the transitional area 202. This in turn has an influence on a function of the injection nozzle 200, particularly with regard to fuel injection quantities and their opening times. This problem exists in particular for all variants of injection nozzles 200 having a conical blind hole 266, regardless of an angle of the nozzle needle seat 262.

According to various embodiments a design modification is made to a transition from the nozzle needle seat 262 into the wall 267 of the blind hole 266, which means that production tolerances resulting from various manufacturing operations no longer have any influence, or virtually no influence, on the hydraulic diameter at the area of intersection 202. Designing a transitional contour from the nozzle needle seat 262 into the wall 267 of the blind hole 266 according to various embodiments makes it possible to influence and to determine the shape of a hydraulic flow curve.

According to various embodiments this is achieved by a cylindrical portion 264, which is situated downstream of the nozzle needle seat 262, the cylindrical portion 264 preferably directly adjoining the nozzle needle seat 262 on the downstream side. Here the cylindrical portion 264 may be part of an offset 264 (see FIG. 3), the cylindrical portion 264 extending in the longitudinal direction L of the nozzle body 20. An intersection edge 263 is thereby produced between the nozzle needle seat 262 and the cylindrical portion 264, which edge is preferably not re-machined separately, but is left after grinding-in and finish-machining the nozzle needle seat 262. It is possible, however to correspondingly re-machine this intersection edge 263, and in particular to radius this.

Adjoining the cylindrical portion 264 of the offset 264 on the downstream side there is then a portion running substantially in a radial direction R of the nozzle body 20, said portion forming an intersection edge with the wall 267 of the blind hole 266. It is again preferred here if the intersection edge and an edge or a transition from the cylindrical portion 264 into the radially running portion is not re-machined separately, that is to say apart from any finish-machining of the blind hole 266, for example. It is again possible, however, to re-machine the intersection edge and the other edge or the transition, and in particular to radius or round these off.

It is also possible, in one embodiment, to provide just one cylindrical portion 264, which is not part of the offset 264 (not represented in FIG. 3), between the nozzle needle seat 262 and the start of the blind hole 266. That is to say the nozzle needle seat 262 merges by way of the intersection edge 263 into the cylindrical portion 264 and the latter merges by way of an intersection edge directly into the start of the blind hole 266.

In the method according to various embodiments a center bore is first introduced as a blind hole into the nozzle body 20. Apart from finish-machining, this center bore in the area of the subsequent needle bore 26 is basically identical to the subsequent needle bore 26. Here the center bore is approximately 80% of the subsequent length of the nozzle bore in the nozzle body 20. The nozzle needle seat 262, the offset 264 or the cylindrical portion 264 and the blind hole 266 are then provided, preferably by means of a single, correspondingly designed tool. The latter machining operation can also be performed by a plurality of tools, however.

An isolated machining operation or a plurality of other machining operations not essential for the invention may be performed between the respective machining operations. This relates, for example, to heat treatment operations, an external contour of the nozzle body 20 in an area of its longitudinal end portion, further edging/milling inside the nozzle bore 22 and/or finish-machining one or more portions of the nozzle bore 22 or the nozzle body 20. In particular, during the finish-machining the cylindrical portion 264 assumes its subsequent height H. Here the height H of the cylindrical portion 264 preferably lies in a range from a few μm to half a millimeter.

In addition an intersection edge between the nozzle needle seat and the offset or the cylindrical portion, and/or an intersection edge between the offset or the cylindrical portion and the start of the blind hole may be machined separately, and in particular radiused, or it may remain unmachined.

What is claimed is:

1. A nozzle body for a nozzle assembly of a fuel injector, in particular or a common-rail fuel injector, comprising:
a needle bore for a needle plunger of a nozzle needle, wherein the needle bore opens out by way of a nozzle needle seat for a sealing face of a nozzle needle tip of the nozzle needle in a blind hole, into which a pintle of the nozzle needle tip is immersible, wherein
an offset is provided in a transitional area from the nozzle needle seat to the blind hole.

2. The nozzle body according to claim 1, wherein the offset inside a wall of the nozzle body has a substantially hollow cylindrical contour.

3. The nozzle body according to claim 1, wherein the nozzle needle seat merges in a longitudinal direction of the nozzle body into the wall of the blind hole by way of the offset embodied as a step.

4. The nozzle body according to claim 1, wherein an intersection edge between the nozzle needle seat and the offset results from an intersection between a cone and a cylinder.

5. The nozzle body according to claim 1, wherein an intersection edge between the offset and the blind hole results from an intersection between a cylinder and a cone.

6. A nozzle assembly for a fuel injector, comprising a defined hydraulic diameter between a nozzle needle and a nozzle body of the nozzle assembly downstream of a nozzle needle seat of the nozzle body, wherein
the nozzle needle is displaceably guided in a nozzle bore of the nozzle body and with a sealing face provided thereon can be brought to bear tightly against the nozzle needle seat of the nozzle body, and the nozzle bore comprises a cylindrical portion downstream of the nozzle needle seat.

7. The nozzle assembly according to claim 6, wherein that the nozzle bore opens out in a blind hole downstream of the cylindrical portion.

8. The nozzle assembly according to claim 6, wherein the nozzle needle, at a nozzle needle tip, comprises a pintle, which is immersible into the blind hole, an external contour of the pintle preferably being of a similar design to an internal contour of the blind hole.

9. The nozzle assembly according to claim 6, wherein the nozzle body comprises a needle bore for a needle plunger of a nozzle needle, wherein the needle bore opens out by way of a nozzle needle seat for a sealing face of a nozzle needle tip of the nozzle needle in a blind hole, into which a pintle of the nozzle needle tip is immersible, wherein
an offset is provided in a transitional area from the nozzle needle seat to the blind hole.

10. The nozzle body according to claim 1, wherein at least one of the nozzle needle seat is of truncated cone-shaped design and the blind hole is internally of conical design.

11. The nozzle body according to claim 1, wherein in a finished state of the nozzle body of the offset or the cylindrical portion is 2 μm to 250 μm, preferably or 5 μm to 100 μm, or 10 μm to 75 μm, or 15 μm to 50 μm or 20 μm to 35 μm.

12. The nozzle body according to claim 1, wherein the intersection edge between the nozzle needle seat and the offset or the cylindrical portion is a sharp edge.

13. The nozzle body according to claim 1, wherein the intersection edge between the nozzle needle seat and the offset or the cylindrical portion is not machined after introducing the offset or the cylindrical portion.

14. A fuel injector, or a common rail fuel injector, for a combustion chamber of an internal combustion engine, comprising
a nozzle body comprising a needle bore for a needle plunger of a nozzle needle, wherein the needle bore opens out by way of a nozzle needle seat for a sealing face of a nozzle needle tip of the nozzle needle in a blind hole, into which a pintle of the nozzle needle tip is immersible, wherein
an offset is provided in a transitional area from the nozzle needle seat to the blind hole, or
a nozzle body comprising a needle bore for a needle plunger of a nozzle needle, wherein the needle bore opens out by way of a nozzle needle seat for a sealing face of a nozzle needle tip of the nozzle needle in a blind hole, into which a pintle of the nozzle needle tip is immersible, wherein an offset is provided in a transitional area from the nozzle needle seat to the blind hole, wherein at least one of the nozzle needle seat is of truncated cone-shaped design and the blind hole is internally of conical design, or
a nozzle assembly comprising a defined hydraulic diameter between a nozzle needle and a nozzle body of the nozzle assembly downstream of a nozzle needle seat of the nozzle body, wherein the nozzle needle is displaceably guided in a nozzle bore of the nozzle body and with a sealing face provided thereon can be brought to bear tightly against the nozzle needle seat of the nozzle body, and the nozzle bore comprises a cylindrical portion downstream of the nozzle needle seat; and
an injector assembly.

15. A method for introducing a nozzle bore in a nozzle body of a fuel injector, in particular a common-rail fuel injector, comprising:
introducing a needle bore of the nozzle bore first before providing a nozzle needle seat in the nozzle body and an offset or a cylindrical portion in or on a wall of the nozzle body internally adjoining the nozzle needle seat in a longitudinal direction of the nozzle body.

16. The method according to claim 15, wherein a blind hole, in which the needle bore of the nozzle body opens out, is furthermore provided in the nozzle body.

17. The method according to claim 15, wherein the nozzle needle seat and the offset or the cylindrical portion and/or the blind hole are provided in the nozzle body by a single tool.

18. The method according to claim 15, wherein the offset or the cylindrical portion are first provided before grinding in the nozzle needle seat.

19. The method according to claim 15, wherein the nozzle body comprises a needle bore for a needle plunger of a nozzle needle, wherein the needle bore opens out by way of a nozzle needle seat for a sealing face of a nozzle needle tip of the nozzle needle in a blind hole, into which a pintle of the nozzle needle tip is immersible, wherein an offset is provided in a transitional area from the nozzle needle seat to the blind hole.

20. The nozzle assembly according to claim 6, wherein at least one of the nozzle needle seat is of truncated cone-shaped design and the blind hole is internally of conical design.

21. The nozzle assembly according to claim 6, wherein in a finished state of the nozzle body of the offset or the cylindrical portion is 2 μm to 250 μm or 5 μm to 100 μm or 10 μm to 75 μm or 15 μm to 50 μm or 20 μm to 35 μm.

22. The nozzle assembly according to claim 6, wherein the intersection edge between the nozzle needle seat and the offset or the cylindrical portion is a sharp edge.

23. The nozzle assembly according to claim 6, wherein the intersection edge between the nozzle needle seat and the offset or the cylindrical portion is not machined after introducing the offset or the cylindrical portion.
